(19) United States
(12) Patent Application Publication
(10) Pub. No.: US 2006/0049752 A1
(43) Pub. Date: Mar. 9, 2006

(54) Organic electroluminescent device

(76) Inventors: Noriyuki Matsusue, Hirakata-city (JP); Hisao Haku, Neyagawa-city (JP)

Correspondence Address: MCDERMOTT WILL & EMERY LLP, 600 13TH STREET, N.W., WASHINGTON, DC, 20005-3096, US

(21) Appl. No.: 11/085,269

(22) Filed: Mar. 22, 2005

(30) Foreign Application Priority Data
Mar. 26, 2004 (JP) 2004-91342

(51) Int. Cl. H05B 33/00

(52) U.S. Cl. 313/506

(57) ABSTRACT

An organic electroluminescent device comprising an organic layer including a light emitting layer, between a hole injection electrode and an electron injection electrode, wherein the electron injection electrode has a laminated structure of a metal thin film containing gold such as MgAu, and an auxiliary electrode composed of a transparent electrically conductive metal oxide thin film formed thereon.

The priority Japanese Patent Application Number 2004-91342 upon which this patent application is based is hereby incorporated by reference.

### BACKGROUND OF THE INVENTION

1. Field of the Invention

The present invention relates to an organic electroluminescent element, more particularly, an organic electroluminescent device having a top emission structure in which emitted light is taken out from a side opposite to a substrate.

2. Description of the Related Art

In recent years, with diversification of information instruments, a demand of a planar display device having a smaller consumed electric power and a smaller volume as compared with a cathode ray tube (CRT) which has previously generally used, has been increased. As one of such the planar display devices, an electroluminescent device (EL device) is paid an attention. This EL device is roughly classified into two kinds depending on a material. That is, the device is roughly classified into an inorganic EL device in which a light emitting layer is formed of an inorganic material, and an organic EL device in which a light emitting layer is formed of an organic material. An inorganic EL device requires a high driving voltage, while an organic EL device has an advantage that it can be driven by a low voltage.

In general, an organic EL device is provided with an organic layer containing a light emitting layer etc. between a hole injection electrode and an electron injection electrode. When a voltage is applied between a hole injection electrode and an electron injection electrode, a hole is injected from a hole injection electrode, and an electron is injected from an electron injection electrode. An injected hole and electron reach a light emitting layer, and are recombined. Upon recombination of a hole and an electron, a molecule of a light emitting material present in a light emitting layer becomes in the excited state and, when this excited molecule is returned to the ground state, fluorescent light or phosphorescence light is emitted.

Usually, emitted light is taken out from a substrate side on which a transparent electrode is formed. However, when an organic EL device is used, for example, in a display, it is preferable to take out light from an electron injection electrode side opposite to a substrate due to preference in a manufacturing step and preference in an opening rate in a thin film transistor (TFT) substrate.

Then, recently, study is being performed in order to make an electron injection electrode transparent. Examples of a material for a transparent electron injection electrode include a material having a small work function such as an alkali metal such as lithium, sodium, potassium, and an alkaline earth metal such as magnesium. However, an alkali metal and an alkaline earth metal are a metal which is unstable in the air. Therefore, in an organic EL device using an electrode material comprising these unstable metals, its instability influences on a device life. Also in a magnesium-silver alloy (MgAg) exhibiting relatively excellent device property, a device life has not reached a practical level.

Then, various transparent electron injection electrodes which are stable in the air have been proposed.

For example, Japanese Patent Laid-Open H8-185984, Japanese Patent Laid-Open H10-162959 and Japanese Patent Laid-Open 2001-291595 disclose a transparent electron injection electrode having a laminated structure of magnesium-silver alloy (MgAg) with indium-tin oxide (ITO) or indium-zinc oxide (IZO).

However, in an organic EL device described in Japanese Patent Laid-Open H8-185984, Japanese Patent Laid-Open H10-162959 and Japanese Patent Laid-Open 2001-291595, a light transmittance and an electrical conductivity of an electron injection electrode are low, and a device life is short. In addition, since a thin film of ITO or IZO is usually formed by a RF sputtering method and, thereupon, a metal thin film composed of MgAg and an organic layer thereunder undergo sputtering damage, there is a problem that a light emitting efficiency is reduced, in an organic EL device using a metal thin film composed of MgAg in an electrode. Japanese Patent Laid-Open 2000-260572 discloses a codeposition film of an inorganic compound and an organic electron transporting material, and a transparent electron injection electrode having a laminated structure with a transparent electrode.

In an organic EL device described in Japanese Patent Laid-Open 2000-260572, although a light transmittance of an electron injection electrode is increased, sputtering damage at formation of a transparent electrode can not be reduced, and there arises a problem such as reduction in a light emitting efficiency.

Japanese Patent Laid-Open 2003-45673 discloses a transparent electron injection electrode having a high light transmittance, which has a laminated structure of aluminum (Al) or magnesium-silver alloy (MgAg) with gold (Au). However, in an organic EL device described in Japanese Patent Laid-Open 2003-45673, a light transmittance of an electron injection electrode is still insufficient, and emitted light can not be effectively taken out.

### SUMMARY OF THE INVENTION

An object of the present invention is to solve the aforementioned prior art problems, and provide an organic EL device in which a light emitting efficiency in a light emitting layer is not reduced and a transmittance of an electron injection electrode is increased to take out emitted light effectively.

The present invention is an organic EL device comprising an organic layer containing a light emitting layer between a hole injection electrode and an electron injection electrode, characterized in that the electron injection electrode has a laminated structure of a metal thin film containing gold, and an auxiliary electrode comprising a transparent electrically conductive metal oxide thin film formed thereon.

In the present invention, by laminating an auxiliary electrode comprising a transparent electrically conductive metal oxide thin film on a metal thin film containing gold, an electron injection electrode is formed. The present inventors found that, when a metal thin film containing gold hardly undergoes sputtering damage when an electrically conductive metal oxide thin film is formed thereon by a sputtering method. Therefore, by using a metal thin film containing gold, it enables for an organic layer which is an underlayer thereof to hardly undergo sputtering damage and, as a result, reduction in a light emitting efficiency in a light emitting layer can be suppressed.

Examples of the metal thin film containing gold in the present invention include a gold simple substance thin film and a gold alloy thin film. As the gold alloy thin film, a magnesium-gold alloy (MgAu) is preferably used. In addition, examples of the gold alloy include an alloy of gold and an alkali metal or an alkaline earth metal. Alternatively, a lamination of a gold simple substance thin film and an alkali metal thin film or an alkaline earth metal thin film may be used.

The auxiliary electrode in the present invention is formed of a transparent electrically conductive metal oxide thin film, and such the electrical conductive metal oxide thin film is not particularly limited, but the transparent electrically conductive metal oxide which has previously generally been used such as ITO and IZO can be used.

A method of forming a metal thin film containing gold in the present invention is not particularly limited, but the film can be formed by various sputtering methods such as a RF sputtering method and an ECR sputtering method, and a vacuum deposition method.

A method of forming an electrically conductive metal oxide thin film in the present invention is not particularly limited, but the film can be formed by various sputtering methods such as a RF sputtering method and an ECR sputtering method.

A thickness of the metal thin film containing gold in the present invention is preferably less than 5 nm, further preferably in a range of 1 to 4 nm. When a thickness of the metal thin film is too thick, a transmittance of the metal thin film in a visible light region is reduced, and light can not be effectively taken out in some cases. On the other hand, when a thickness of the metal thin film is too thin, at formation of an auxiliary electrode, sputtering damage on an organic layer which is an underlayer can not be reduced in some cases.

In the present invention, a thickness of an auxiliary electrode is preferably greater than a thickness of the metal thin film. When a thickness of the auxiliary electrode is too thin, sufficient electrical conductivity as an auxiliary electrode can not be exerted in some cases.

In the present invention, a transmittance of an electron injection electrode in a visible light region is preferably 60% or more. When a transmittance is less than 60%, emitted light can not be effectively taken out in some cases.

A hole injection electrode in the present invention is not particularly limited, but the hole injection electrode which has previously generally been used can be used and, for example, the electrode can be formed of a transparent electrically conductive metal oxide such as ITO and IZO.

The organic layer in the present invention is disposed between a hole injection electrode and an electron injection electrode, and contains a light emitting layer. In addition to the light emitting layer, a carrier transporting layer and a carrier injecting layer such as an electron transporting layer, a hole transporting layer, an electron injecting layer, and a hole injecting layer can be appropriately disposed.

The organic electroluminescent device of the present invention is an organic electroluminescent device suitable in a top emission structure. Therefore, it is preferable that light emitted in a light emitting layer is taken out at least from an electron injection electrode side. In this case, a structure by which light is taken out also from a substrate side may be used.

In addition, in the present invention, a light emitting layer may be constructed of a plurality of light emitting layers. For example, the light emitting layer may be a device emitting white light by disposing a blue emitting layer and an orange emitting layer by lamination. In this case, by making a thickness of a metal thin film containing gold less than 5 nm, a transmittance can be increased, and white emitting having better tone can be obtained. That is, when a thickness of the metal thin film containing gold becomes 5 nm or more, the metal thin film becomes a resonator structure, and a white color having better tone is not obtained in some cases.

According to the present invention, damage which an organic layer undergoes upon manufacturing of a light emitting device can be reduced. For this reason, an organic electroluminescent device having a high light emitting efficiency can be obtained. In addition, a light transmittance of an electron injection electrode can be increased, and light from a light emitting layer can be effectively taken out.

### BRIEF DESCRIPTION OF THE DRAWINGS

FIG. 1 is a view showing a permeation spectrum of a MgAu thin film, an Au thin film and a MgAg thin film.

FIG. 2 is a view showing an emitting spectrum of an organic electroluminescent device of one example in accordance with the present invention.

FIG. 3 is a view showing an emitting spectrum of an organic electroluminescent device of other example in accordance with the present invention.

FIG. 4 is a view showing an emitting spectrum of an organic electroluminescent device of still other example in accordance with the present invention.

### DESCRIPTION OF THE PREFERRED EXAMPLES

The present invention will be explained in detail below by way of Examples, but the present invention is not limited to the following Examples, and can be practiced by appropriate alteration as far as the gist thereof is not changed.

### EXAMPLE 1

A molybdenum (Mo) thin film having a thickness of 100 nm as a light reflecting film was formed on a glass substrate and, thereafter, an ITO thin film having a thickness of 60 nm as a hole injection electrode was formed on this Mo thin film.

Then, this glass substrate on which the light reflecting film and the hole injection electrode were formed was washed with a neutral detergent, and ultrasound-washed in pure water for 10 minutes and, further, in ethanol for 10 minutes. After ultrasound washing, a surface of the glass substrate was washed with an ozone cleaner.

After washed with an ozone cleaner, a hole injecting layer composed of a CuPu thin film having a thickness of 10 nm, a hole transporting layer composed of a NPB thin film having a thickness of 50 nm, a light emitting layer composed of an Alq thin film having a thickness of 70 nm, and a metal thin film containing Au composed of a MgAu (atomic ratio Mg:Au=1:1) thin film having a thickness of 3 nm were formed in this order on the substrate comprising the ITO thin film formed thereon. Any of layers was formed under conditions of a vacuum degree 1×10⁻⁶ Torr without control of a substrate temperature by a vacuum deposition method. CuPc, NPB and Alq are the following compounds.
CuPu: copper phthalocyanine
NPB: bis{N-(1-naphthyl)-N-phenyl}benzidine
Alq: tris(8-quinolinol)aluminum complex

Then, an auxiliary electrode comprising an IZO thin film having a thickness of 50 nm was formed on a metal thin film containing Au. Thin film forming conditions were conditions of a pressure 1.9×10⁻¹ Pa and RF output 300 W, and the electrode was formed by an ECR spattering method. As a spattering gas, a mixed gas of a Kr gas and an O₂ gas was used, and a ratio of incorporating an O₂ gas was 0.3%.

### EXAMPLE 2

According to the same manner as that of Example 1 except that a thickness of a metal thin film containing Au was 1 nm, an organic electroluminescent device was prepared.

### COMPARATIVE EXAMPLE 1

According to the same manner as that of Example 1 except that a MgAg thin film having a thickness of 3 nm was formed in place of the metal thin film containing Au, an organic electroluminescent device was prepared.

### COMPARATIVE EXAMPLE 2

According to the same manner as that of Comparative Example 1 except that a thickness of a MgAg thin film was 1 nm, an organic electroluminescent device was prepared.

[Assessment of Light Emitting Property]

Light emitting property was assessed by applying a voltage to the organic electroluminescent devices prepared in Examples 1 and 2 as well as Comparative Examples 1 and 2. A voltage was applied by biasing a hole injection electrode plus, and an electron injection electrode minus.

In the organic electroluminescent devices in Examples 1 and 2, green uniform emitting due to Alq was obtained at a light emitting area of 3 mm×3 mm. To the contrary, in the organic electroluminescent devices of Comparative Examples 1 and 2, uniform light emitting was not obtained. The reason why uniform emitting was obtained in the organic electroluminescent devices of Examples 1 and 2 is thought that a MgAu thin film disposed on an organic layer containing a light emitting layer protected the organic layer so that the layer does not undergo spattering damage, upon formation of an IZO thin film. It is thought that uniform light emitting was obtained from a light emitting layer based on this reason.

[Measurement of Transmittance of Metal Thin Film]

A MgAu thin film, an Au thin film and a MgAg thin film were formed on a glass substrate, and a transmittance of each thin film was measured. A MgAu thin film and an Au thin film were prepared at three kinds of thicknesses of 1 nm, 3 nm and 5 nm, and a transmittance was measured. A MgAg thin film was prepared at two kinds of thicknesses of 3 nm and 5 nm, and a transmittance was measured. A MgAg thin film could not be formed as a uniform thin film having a thickness of 1 nm.

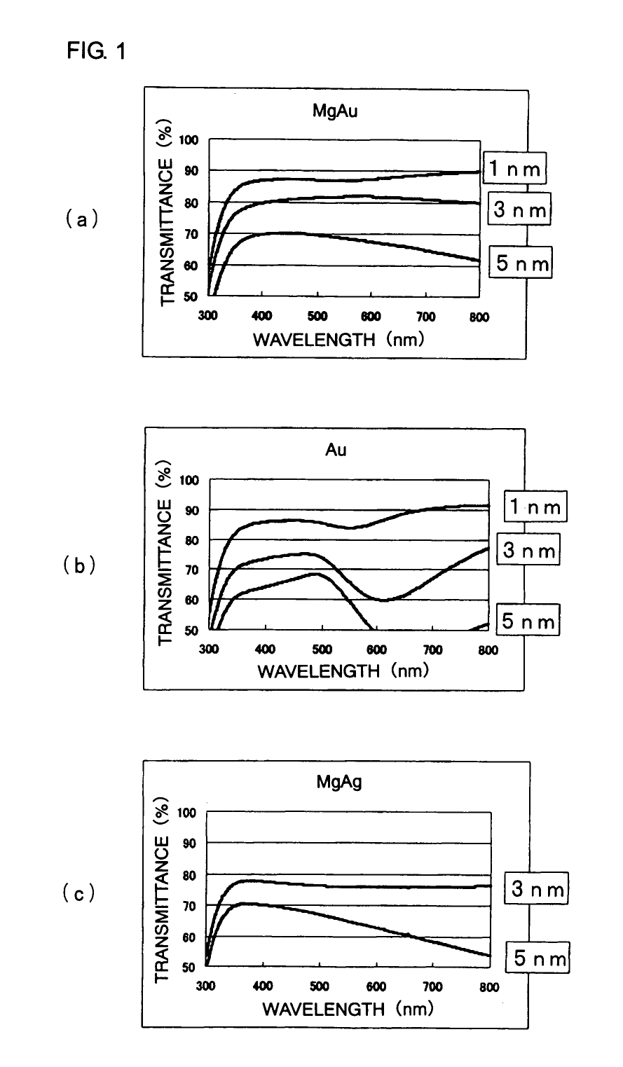

FIG. 1 is a view showing a permeation spectrum of each thin film. FIG. 1 (a) is a permeation spectrum of a MgAu thin film, and (b) is a permeation spectrum of an Au thin film. And, (c) is a permeation spectrum of a MgAg thin film.

As apparent from FIG. 1 (a), a MgAu thin film is a thin film having a thickness of less than 5 nm, and a transmittance at a visible light regions is 60% or more. An Au thin film has a thickness of 3 nm or less, and a transmittance at a visible light region is 60% or more.

As shown in FIG. 1 (c), the MgAg thin film which has previously been used shows a slightly lower transmittance than that of a MgAu thin film.

### EXAMPLE 3

A blue emitting layer and an orange emitting layer as a light emitting layer were formed, and an organic electroluminescent device emitting a white color was prepared. The orange emitting layer was formed of a NPB thin film (thickness 30 nm) containing 3% by weight of DBZR. In addition, the blue emitting layer was formed of a TBADN thin film (thickness 40 nm) containing 2% by weight of TBP. The orange emitting layer was formed on a hole transporting layer, and the blue emitting layer was formed thereon. According to the same manner as that of Example 1 except that a thickness of the hole transporting layer was 65 nm, a thin film (thickness 10 nm) composed of Alq and Li (lithium)(Alq:Li=1:1) as an electron transporting layer was formed, an Au simple substance thin film (thickness 3 nm) as a metal thin film containing gold was formed, and an IZO thin film (thickness 25 nm) as an auxiliary electrode was formed, an organic electroluminescent device was prepared.
TBADN, TBP and DBZR are the following compounds.
TBADN: 2-tert-butyl-9,10-di(2-nephtyl)anthracene
TBP: 2,5,8,11-tetra-tert-butylperylene DBzR: 5,12-bis{4-(6-methylbenzothiazol-2-yl)phenyl}-6,11,diphenyl naphthacene

### EXAMPLE 4 According to the same manner as that of Example 3 except that a thickness of an Au simple substance thin film was 1 nm, an organic electroluminescent device was prepared.

### EXAMPLE 5

According to the same manner as that of Example 3 except that a thickness of an Au simple substance thin film was 5 nm, an organic electroluminescent device was prepared.

[Assessment of Light Emitting Property]

Light emitting property was assessed by applying a voltage by biasing a hole injection electrode of organic electroluminescent devices obtained in Examples 3 to 5 plus, and an electron injection electrode minus.

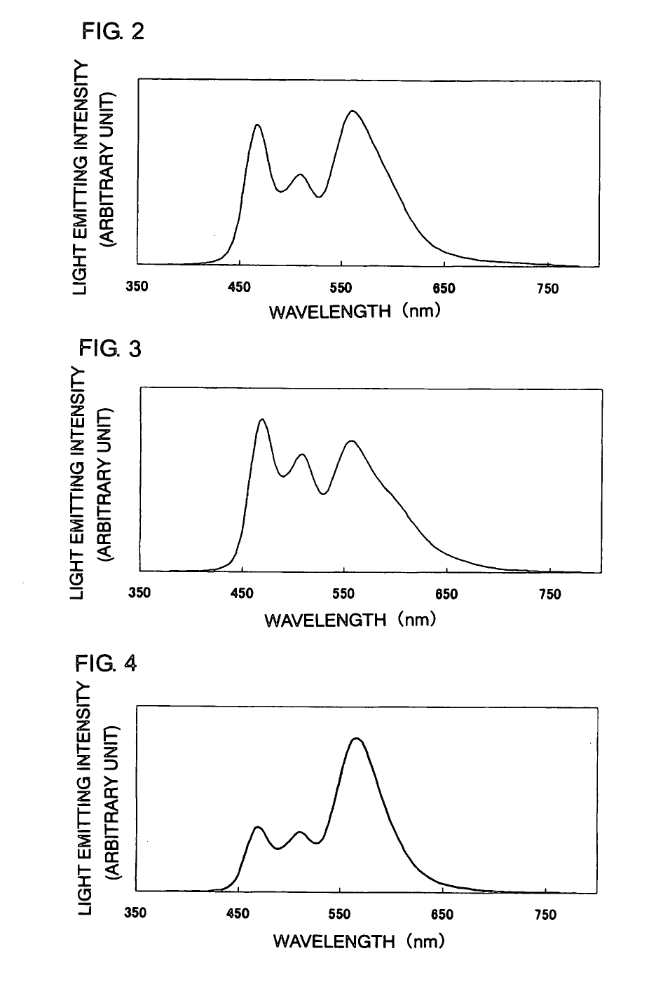

FIG. 2 is an emitting spectrum of the device of Example 3, FIG. 3 is an emitting spectrum of the device of Example 4, and FIG. 4 is an emitting spectrum of the device of Example 5. As apparent from FIG. 2 and FIG. 3, white color emission is obtained in devices of Example 3 and 4. To the contrary, as apparent from FIG. 4, orange emission is obtained in the organic electroluminescent device of Example 5. This is thought that since a thickness of an Au simple substance thin film is 5 nm, a resonator structure is formed, and an orange color is stressed. Therefore, it is seen that, when a white emitting device is prepared, a thickness of an Au simple substance thin film is preferably less than 5 nm.

### EXAMPLE 6

A hole injection electrode (anode) composed of indium-tin oxide (ITO), a hole injecting layer composed of CuPc, a hole transporting layer composed of NPB, a light emitting layer composed of Alq, an electron injecting layer composed of Li, a first metal thin film composed of Ag, and a second metal thin film composed of Au were formed in this order on a glass substrate. Specifically, first, a substrate in which an ITO film was formed on a glass substrate was washed with a neutral detergent, and ultrasonic-washed in pure water for 1 minute, and in ethanol for 10 minutes, and a surface was washed with an ozone cleaner. Thereafter, a hole injecting layer, a hole transporting layer, a light emitting layer, an electron injecting layer, a first metal thin film, and a second metal thin film were formed and laminated in this order on a hole injection electrode composed of an ITO film of a substrate, by a vacuum deposition method. Deposition was performed at a vacuum degree of 1×10⁻⁶ Torr under condition without control of a substrate temperature regarding any thin film. Then, an auxiliary electrode composed of an IZO thin film was formed on a second metal thin film composed of Au. The thin film forming conditions were the same as conditions for forming an IZO thin film in Example 1.

A thickness of a hole injecting layer is 10 nm, a thickness of a hole transporting layer is 50 nm, a thickness of a light emitting layer is 70 nm, a thickness of an electron injecting layer is 1 nm, a thickness of a first metal thin film is 5 nm, a thickness of a second metal thin film is 15 nm, and a thickness of an auxiliary electrode is 100 nm. In this organic EL device, an electron injection electrode (cathode) is constructed of a first metal thin film, a second metal thin film and an auxiliary electrode.

### COMPARATIVE EXAMPLE 3

According to the same manner as that of Example 6 except that an auxiliary electrode composed of an IZO thin film was formed on a first metal thin film composed of Ag of a thickness of 20 nm without forming a second metal thin film composed of Au in Example 6, an organic electroluminescent device was prepared.

[Assessment of Light Emitting Property]

Light emitting property was assessed by applying a voltage to organic electroluminescent devices prepared in Example 6 and Comparative Example 3. A voltage was applied by biasing a hole injection electrode plus, and an electron injection electrode minus.

In the organic electroluminescent device of Example 6, green uniform emission due to Alq was obtained at a light emitting area of 3 mm×3 mm. To the contrary, in the organic electroluminescent device of Comparative Example 3, uniform emission was not obtained. The reason is considered that an organic layer was protected so that it did not undergo sputtering damage when a second metal thin film composed of Au forms an IZO thin film.

What is claimed is:

1. An organic electroluminescent device comprising an organic layer including a light emitting layer, between a hole injection electrode and an electron injection electrode,
wherein the electron injection electrode has a laminated structure of a metal thin film containing gold, and an auxiliary electrode composed of a transparent electrically conductive metal oxide thin film formed thereon.

2. The organic electroluminescent device according to claim 1, wherein emitted light is taken out from at least an electron injection electrode side.

3. The organic electroluminescent device according to claim 1, wherein transmittance of the electron injection electrode in a visible light region is 60% or more.

4. The organic electroluminescent device according to claim 1, wherein a thickness of the metal thin film is less than 5 nm.

5. The organic electroluminescent device according to claim 1, wherein a thickness of the auxiliary electrode is greater than a thickness of the metal thin metal.

6. The organic electroluminescent device according to claim 1, wherein the metal thin film is made of an alloy of gold and magnesium.

7. The organic electroluminescent device according to claim 1, wherein the auxiliary electrode is made of indium-tin oxide or indium-zinc oxide.

8. The organic electroluminescent device according to claim 1, wherein the organic electroluminescent device is a white emitting device.
